(19) United States
(12) Patent Application Publication
(10) Pub. No.: US 2006/0068248 A1
(43) Pub. Date: Mar. 30, 2006

(54) High efficiency system for low cost conversion of fuel to vehicle hydrogen

(75) Inventor: Robert C. Ruhl, Cleveland Heights, OH (US)

Correspondence Address: D. Hochberg;D. Peter Hochberg Co., L.P.A., 6th Floor, 1940 East 6th St., Cleveland, OH, 44114, US

(73) Assignee: Technology Management, Inc.

(21) Appl. No.: 11/056,672

(22) Filed: Feb. 12, 2005

Related U.S. Application Data
(60) Provisional application No. 60/543,988, filed on Feb. 12, 2004.

(51) Int. Cl. H01M 8/18; H01M 8/12

(52) U.S. Cl. 429/21; 429/34; 429/32

(57) ABSTRACT

An electrochemical system for the direct conversion of carbonaceous fuel into electrical energy and/or pure hydrogen. The system comprises at least two solid oxide fuel cell stack assemblies in communication with the other for production of hydrogen/electricity. The solid oxide fuel cell stack assemblies are in communication with a compressor, which in turn compresses the produced hydrogen into compressed pure hydrogen for storage and later use.

### CROSS REFERECE TO RELATED APPLICATION

This application claims the benefit of U.S. Provisional Application No. 60/543,988, filed Feb. 12, 2004, under Title 35, United States Code, Section 119(e).

### FIELD OF THE INVENTION

The present invention relates generally to electrochemical systems, such as solid-oxide electrolyte fuel cells, electrolyzers, and assemblies thereof for the direct conversion of chemical energy into electricity, or from electricity into chemical energy. More particularly, the present invention relates to a high efficiency, low cost system for the conversion of fuel into hydrogen.

### DESCRIPTION OF THE PRIOR ART

Health costs associated with air pollution are an escalating problem in modern society. The burning of gasoline and diesel in the engines of wheeled vehicles is a significant contributor to this problem. It has been widely recognized that vehicles fueled by hydrogen, and those preferably using on board fuel cell systems to generate electric power from hydrogen, could significantly reduce air pollution and potentially could also reduce greenhouse gas emissions. It has also been widely recognized and accepted that the hydrogen fuel cell is an attractive alternative to the internal combustion engine for producing electricity because it is highly efficient, while not being a significant source of pollution, namely of greenhouse gas emissions.

An example of an economical and widely used method for producing hydrogen from fuels is through the use of large plants employing steam reforming, water-gas shift, and gas separation. The hydrogen is then typically transported by truck to user sites. The overall energy efficiency of delivered hydrogen via this route is typically below 70% (hydrogen lower heating value/fuels lower heating value).

Distributed plants using small variants of the above are also known, but tend to exhibit lower efficiencies, higher costs, and unwanted pollution/waste issues.

A fuel cell is essentially an electrochemical device that converts chemical energy produced by a reaction directly into electrical energy. A fuel cell operating in reverse is termed an electrolyzer and converts electrical energy into chemical energy. Hydrogen, for example, is also produced from electric power and water using polymer electrolyte membrane (PEM) electrolyzers, often also referred to as a proton exchange membrane, which permits only protons to pass through their electrolytes. However, such electrolyzers typically operate near 2.0 volts per cell and (when operated using electric power from conventional fuel cell systems) result in relatively poor fuel-to-hydrogen energy efficiencies, such as below 40%.

The use of large trucks or pipelines to transport hydrogen from large production plants (i.e., a “hydrogen infrastructure”) to a work site also poses safety and security risks when compared with on site production.

Therefore, there exists a need for a more cost-efficient, safer and more secure decentralized system capable of on-site production of pure high-pressure hydrogen suitable for use with fuel-cell powered vehicles.

### SUMMARY OF THE INVENTION

An aspect of the present invention is the system's tandem arrangement of solid oxide fuel cell stacks, such as stacks adapted for the direct injection of carbonaceous fuels, with a reversible fuel cell system. The former is the subject of co-pending U.S. application Ser. No. 10/141,281, the description of which is fully incorporated by reference herein. The latter is the subject of U.S. application Ser. No. 09/992,272 (now U.S. Pat. No. 6,811,913), the description of which is also fully incorporated by reference herein. The two aforementioned types of cell stacks are mounted inside a common insulated hot chamber for allowing more efficient electrochemical operation and resulting in a very high combined efficiency and low cost of production of both hydrogen and electricity. Moreover, this system could be operated with some or all of the reversible stacks in a fuel cell mode, thus producing more electric power and less or even no hydrogen. Such operation could be useful when hydrogen storage tanks become full or electric prices are relatively high.

It is an object of the present invention to provide a field-expandable modular system to meet the hydrogen needs of a single vehicle up to any number of vehicles.

Another object of the present invention is to provide a modular system that can be located at any number of locations, such as at residences, filling stations, fleet garages, businesses and the like.

Yet another object of the present invention is to provide a system to produce adjustable or varying quantities of hydrogen, electric power and usable heat. The fuel feedstock would be a clean gaseous or liquid carbonaceous fuel, such as natural gas, propane, gasoline, kerosene, ethanol, vegetable oil or any other comparable material, along with purified water and ambient air.

Still yet another object of the present invention is to provide a system for producing very pure hydrogen at any desired pressure, such as 40 MPa, and storing the produced hydrogen for later use in vehicles.

Yet another object of the present invention is to provide a system having exhaust that is very clean and which the hot water co-product could optionally be used for space heating or other typical uses. The compressor of the present invention can be any compressor standard in the art, such as a multistage electromechanical unit or another type such as a hydride thermochemical system. The system could also be configured to accept electric power, for example from renewable sources, such as photovoltaic panels or wind turbines, so as to reduce fuel consumption.

Another object of the present invention is to provide an improved system for the conversion of fuel to pure hydrogen.

Still another object of the present invention to provide a system for the conversion of fuel to hydrogen that is cost-effective, secure and safe.

Yet another object of the present invention is to provide a system for producing adjustable quantities of hydrogen, electric power and usable heat.

Still yet another object of the present invention is to provide a more efficient system for converting fuel to hydrogen.

Yet another object of the present invention is to provide a system for converting fuel to hydrogen in which the system has low production costs.

### BRIEF DESCRIPTION OF THE DRAWINGS

FIG. 1 is a schematic drawing of the system of the present invention.

FIG. 2 is a schematic drawing of one aspect of the system of the present invention.

FIG. 3 is an exploded, schematic view of one cell from a stack of like cells of the system of the present invention.

FIG. 4 is an exploded, schematic view of one cell from an alternative stack of like cells of the system of the present invention.

### DETAILED DESCRIPTION OF THE PREFERRED EMBODIMENTS

The present invention is now described with reference to the drawings, wherein like reference numerals are used to refer to like elements throughout. In the following description, for purposes of explanation, numerous specific details are set forth in order to provide a thorough understanding of the present invention. It will be evident, however, to one skilled in the art that the present invention may be practiced without these specific details.

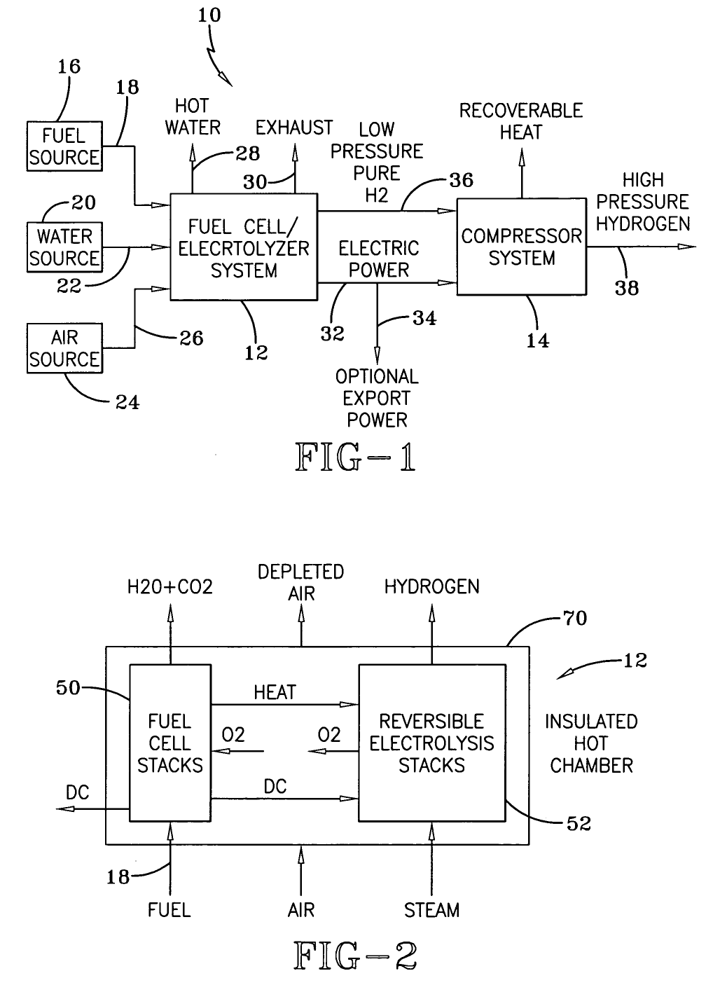

Referring now to FIG. 1, a general overview of a system for the conversion of fuel into energy and/or hydrogen according to the present invention is shown and described and referred to generally at numeral 10. System 10 includes a fuel cell/electrolyzer system 12 communicably connected to a compressor system 14. A more detailed description of fuel cell/electrolyzer system 12 is set forth below. System 10 produces adjustable quantities of hydrogen, electric power and usable heat as hot water. A fuel feedstock is obtained from a fuel source 16 and is connected to fuel cell/electrolyzer system 12 via a fuel feedstock connection or fuel connector 18 to provide fuel to fuel cell/electrolyzer system 12. Fuel feedstock may be, for example, a clean gaseous or liquid carbonaceous fuel, such as natural gas, propane, gasoline, kerosene, ethanol, vegetable oil, or any other comparable fuel compound or mixture.

A water source 20 is connected to fuel cell/electrolyzer system 12 by a water source connection 22 to provide purified water to fuel cell/electrolyzer system 12. An air source 24 is connected to fuel cell/electrolyzer system 12 via an air source connection 26 to provide oxygen, generally in the form of filtered ambient air to fuel cell/electrolyzer system 12.

Still referring to FIG. 1, fuel cell/electrolyzer system 12 further includes a water export tube 28 and exhaust duct 30. Hot water exits fuel cell/electrolyzer system 12 via water export tube 28 where it can be stored for later use or for use with space heating, or other similar uses, when tube 28 is directly connected to such a system. Exhaust duct 30 allows waste gas, which is very clean relative to typical exhaust produced in conventional systems, to exit fuel cell/electrolyzer system 12 where it can be vented and/or utilized for space heating.

An electric power connector 32, or any other apparatus or method known in the art for facilitating electrical communication between fuel cell/electrolyzer system 12 and compressor system 14, electrically connects fuel cell/electrolyzer system 12 with compressor system 14 for transporting electric power produced by fuel cell/electrolyzer system 12 to compressor system 14. Fuel cell/electrolyzer system 12 produces the electric power (and/or hydrogen, as discussed below) by methods known in the art, or in the manner set forth in U.S. application Ser. No. 10/141,281 (a solid oxide fuel cell system for the direct injection of carbonaceous fuels) or U.S. Pat. No. 6,811,913 (a reversible solid oxide fuel cell system), both of which are fully incorporated herein by reference, as noted above. An optional power export line 34 may be connected to electric power connector 32 for diverting some of the electric power produced by fuel cell/electrolyzer system 12 for other uses which need electric power (not shown).

A low pressure pure hydrogen (H₂) connector 36 directs pure hydrogen produced by fuel cell/electrolyzer system 12 to compressor system 14. Compressor system 14 compresses the pure hydrogen which is then transported at a higher pressure to a suitable storage tank via a high pressure hydrogen connector 38. Heat generated by compressor system 14 exits compressor system 14 and, if desired, is recoverable for other purposes.

Turning now to FIG. 2, a more detailed description of fuel cell/electrolyzer system 12 is provided. Fuel cell/electrolyzer system 12 comprises a plurality of solid oxide fuel cells arranged into a stack 50 and a reversible (fuel cell/electrolyzer) solid oxide electrolysis stack 52. It should be appreciated that typically more than one of each of stacks 50 and stacks 52 are employed, but for purposes of explanation, just one of each is shown and described. With the present invention, a tandem arrangement is provided which includes a fuel cell stack 50 and a reversible (fuel cell/electrolyzer) electrolysis stack 52 mounted inside a common insulated chamber 70 for permitting thermal radiation between the stacks 50 and 52. Such a system and system configuration allows extraordinarily efficient electrochemical operation and is capable of a very high combined efficiency and low cost of production of both hydrogen and electricity.

As shown in FIG. 2 and as noted above, a fuel feedstock is provided via a fuel feed tube assembly 18 which provides a liquid or gaseous fuel or fuel mixture to fuel cell stack 50. Fuel cell stack 50 generates DC power and heat. A portion of both the DC power and the heat may be used by reversible electrolysis stack 52 for powering the electrolysis of steam in reversible electrolysis stack 52. Moreover, some of the oxygen consumed by the fuel cells in stack 50 would come from electrolysis, with the remainder coming from the ambient air. Heat exchange (not shown) would pre-heat air and steam from the three hot exit streams. In addition, stack 50 and reversible stack 52 could be comprised of identical cells, with either the same or a different numbers of cells. Reversible stack 52 is typically connected to valves and contactors (not shown) outside thermal insulation chamber 70 for the purpose of reversing the operation of reversible stack 52 between an electrolysis mode and a fuel cell mode, such operation described in detail in the aforementioned '913 U.S. patent. It should be appreciated that all pressures are close to ambient and steam would be generated externally using part of the surplus heat of fuel cell/electrolyzer system 12 and/or compressor system 14. Some of the DC power would power compressor system 14 and system auxiliary equipment (not shown) as well.

Fuel stream 18 may also consist of the output from a fuel processing system (not shown), such as a steam reformer system which is heated using a portion of the heat released by the fuel cell stacks and/or by a portion of the heat in the hot gas streams exiting the hot chamber.

Fuel cell/electrolyzer system 12 may also be operated with some (or all) of reversible stacks 52 in a fuel cell mode, thereby producing more electric power and less hydrogen, or even no hydrogen at all. As previously noted, such an operation would be useful when hydrogen storage tanks become full or electric power prices are high. It should also be appreciated that the fuel cell stacks 50 could be of a different type from the reversible electrolysis stacks 52, such as solid oxide fuel cell stacks for the direct injection of carbonaceous fuels, a detailed description of which is set forth in co-pending U.S. patent application Ser. No. 10/141,281, fully incorporated herein by reference, as established above, and neither stack 50 or reversible stack 52 is limited to a single particular design or geometry. For example, either could be annular or have any other geometry. In this instance, when fuel cell stacks 50 are for the direct injection of carbonaceous fuels, natural gas may serve as the carbonaceous fuel. The stacks 50 could include a forced flow design, possibly operating with reverse cathode flow where exhaust is used as the oxidizing gas and exiting through the center of stack.

It should be appreciated that system 10 can have varying proportions of electricity production and hydrogen production. In other words, system 10 can be configured so as to produce only electricity and no hydrogen, all hydrogen and no electricity or any intermediate amount of both electricity and hydrogen. It should also be appreciated that system 10 is more efficient when producing at least some of both electricity and hydrogen.

The amount and/or type of product produced by system 10 at a particular volume may also depend on external factors, such as pricing of the types of fuel needed, product demand, varying costs of electricity at different times of the day, etc. For example, in one embodiment of the present invention, system 10 may be configured to produce varying amounts of electricity and hydrogen throughout the day. In other words, system 10 can be configured for hydrogen production during the night, or off-peak hours, while electricity costs are relatively low. More electricity is consumed by system 10 for hydrogen production while electricity prices are relatively low. The produced hydrogen can be stored accordingly for sale at a later time or for later use by system 10. In turn, system 10 would then be configured for electricity production during the day, or peak hours, while electricity costs are relatively high. In other words, while in this mode, system 10 would be configured to consume low or even no electricity, while producing mostly or all electricity, while the cost of electricity is fairly high. Such a configuration would enable system 10 to be highly cost efficient. In this regard, system 10 would include at least one reversible electrochemical system, as discussed above.

In another embodiment of the present invention, system 10 is a frozen or fixed system producing the same types and amounts of electricity and/or hydrogen. In this regard, multiple systems may be employed, each producing varying amounts of hydrogen and/or electricity. Additionally, with this embodiment, the stacks would not include a reversible cell stack system, but rather would just include unidirectional electrochemical systems.

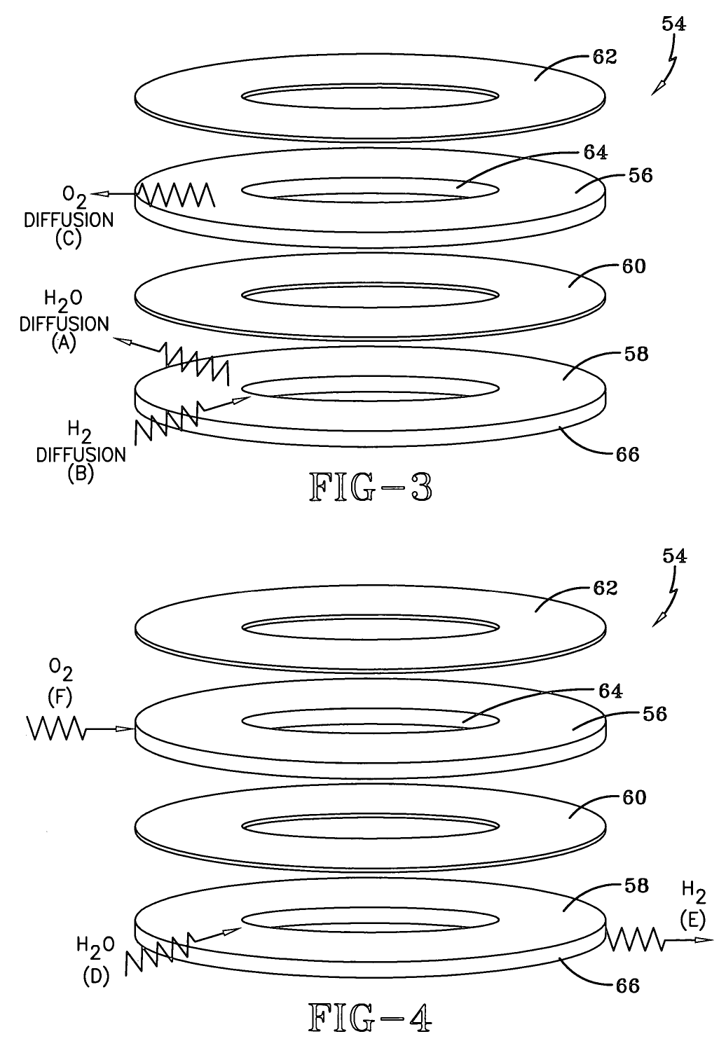

Turning now to FIGS. 3 and 4, an exploded schematic drawing of a cell 54 employed with the present invention is shown and described, a plurality of which are combined to form fuel cell stack 50 or reversible stack 52 (FIG. 2). Cell 54 includes an oxygen electrode/oxygen diffusion layer 56, a fuel electrode/fuel diffusion layer 58, and an electrolyte disc 60 between fuel electrode/fuel diffusion layer 58 and oxygen electrode/oxygen diffusion layer 56. A metal separator disc 62 is placed between oxygen electrode/oxygen diffusion layer 56 and the fuel electrode of an adjacent cell (not shown) in order to separate cell 54 from an adjacent cell (not shown) which is stacked on illustrated cell 54. Depending on the relative order of placement of electrodes/diffusion layers 56 and 58 in reversible stack 52, separator disc 62 could be above oxygen electrode/oxygen diffusion layer 56 and below the fuel electrode of the adjacent cell (not shown) or alternatively above fuel electrode/fuel diffusion layer 58 and below an oxygen electrode of an adjacent cell (not shown). An annular seal 64 is inside oxygen electrode 56. A second annular seal 66 surrounds fuel electrode 58. In this instance, each of the aforementioned components of cell 54 are annular with a hollow center; however it should be appreciated that the components of cell 54 can include any shape conventional in the art such as ovoid or polygonal. Electrolyte disc 60 can be made from an impervious yttria-stabilized zirconia, or any other suitable material, so that it is at least substantially impervious to gases and a good conductor of oxygen ions. Separator disc 62, which separates and electrically connects each cell from an adjacent cell, is comprised of any material common in the field, such as a heat resistant metal alloy such as a high-temperature alloy which forms a thin protective oxide surface layer with good high-temperature electrical conductivity. A thin layer of ink, such as an ink made from a finely-divided electrode composition, may be applied on each side of separator disc 62 to improve the electrical contact between the components of cell 54. Both the oxygen diffusion layer and fuel diffusion layer portions of oxygen electrode/diffusion layer 56 and fuel electrode/diffusion layer 58, respectively, should be highly porous and sufficiently thick so as to allow the requisite gases to diffuse therethrough easily with only moderate composition gradients. The oxygen diffusion layer can be made of, for example, highly porous lanthanum strontium manganite. The fuel diffusion layer can be made of a highly porous nickel metal. Both oxygen electrode 56 and fuel electrode 58 should be comprised of an electrochemically active material having good electrical conductivity, such as porous lanthanum strontium manganite plus yttria-stabilized zirconia for oxygen electrode 56 and porous nickel plus dopes ceria for fuel electrode 58. Nickel foam may also be used for the fuel diffusion layer, except in cells operating on fuel mixtures with very high oxygen potentials. Both oxygen electrode annular seal 64 and fuel electrode annular seal 66 can be made of a glass ceramic.

It should be understood that the cell structure described herein is a description of one cell structure that may be employed with the present invention and that the system of the present invention is not limited to use with just the cell structure described above.

In an electrolysis mode, i.e. a hydrogen production mode, (FIG. 3) DC power is supplied to cell 54 of reversible electrolysis stack 52 at a voltage at least above equilibrium potential, such as Nernst potential or EMF. Cell 54 is typically maintained at about 800° to 950° C. The water vapor in cell 54 is electrolyzed into hydrogen and oxygen and the H₂O and H₂ gases diffuse in opposite directions through fuel electrode 58, which is highly porous, as shown in FIG. 3. H₂O gas diffuses out of cell 54 via fuel electrode 58, shown schematically at arrow A, while H₂ gas diffuses into cell 54 via fuel electrode 58, shown schematically at arrow B. O₂ gas is released into oxygen electrode 56, which is also highly porous, from which it exits via diffusion through the nitrogen-rich gas mixture present surrounding cell 54, as shown schematically at arrow C.

In a fuel cell mode, i.e. an electricity production mode, (FIG. 4) DC power is extracted from cell 54 by operating at a voltage below equilibrium potential. In this instance, the H₂O and H₂ gases also diffuse in opposite directions through fuel electrode 58, but as shown in FIG. 4, H₂O gas diffuses into cell 54 via fuel electrode 58, shown by arrow D, while H₂ gas diffuses out of cell 54 via fuel electrode 58, shown by arrow E. O₂ gas diffuses into cell 54 from an oxygen source via oxygen electrode 56, shown at arrow F. Air is typically used as the oxygen source and the fuel may be a carbonaceous gas mixture derived from partially oxidized or steam reformed fuel and consisting mainly of H₂, H₂O, CO and CO₂. Both H₂ and CO act as fuel components in fuel electrode 58, which is tolerant of CO and also any H₂S impurities which may be present.

Preliminary cost calculations, which depend upon numerous assumptions and external factors, provide hydrogen total production costs of $1.50/kg using natural gas at $6.70/mcf. The corresponding cost of AC power production, according to the present invention, was 3.5 cents/kWh.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. It would be evident to one familiar with the art that the cells of the system of the present invention need not be identical. The object of the present invention may be performed with a system not having like cells, or cells of varying thicknesses in a single system or even comprising varying materials in a single system. Accordingly, the present invention is intended to embrace all such alterations, combinations, modifications, and variations that fall within the spirit and scope of the appended claims.

I claim:

1. A system for the conversion of chemical energy into electrical energy and/or hydrogen, and/or the conversion of electrical energy into chemical energy, said system comprising:
a fuel cell/electrolyzer system comprising at least two solid oxide fuel cell stack assemblies in communication with each other, wherein said fuel cell/electrolyzer system produces at least one of electricity and pure hydrogen;
a compressor system in communication with said fuel cell/electrolyzer system for compressing pure hydrogen produced by said fuel cell/electrolyzer system into a high pressure hydrogen;
an apparatus for electrically connecting said fuel cell/electrolyzer system with said compressor to effect said communication for directing electricity produced by said fuel cell/electrolyzer system to said compressor;
a hydrogen connector for operatively connecting said fuel cell/electrolyzer system with said compressor for directing hydrogen produced by said fuel cell/electrolyzer system to said compressor;
an intake H₂0 feed for operatively connecting said fuel cell/electrolyzer system with an external water source for feeding water into said system;
a fuel feed connector for operatively connecting said fuel cell/electrolyzer system with an external fuel source for feeding fuel into said system;
a water export tube extendable from said fuel cell/electrolyzer system for directing heated water away from said system;
an oxygen bearing gas intake tube connectable to said fuel cell/electrolyzer system for providing oxygen to said system from an oxygen source;
an exhaust tube extendable from said fuel cell/electrolyzer system for directing waste gas away from said system; and
a high pressure hydrogen connector extendable from said compressor for directing the high pressure hydrogen away from said compressor to an external storage facility.

2. The system according to claim 1, wherein said at least two solid oxide fuel cell stack assemblies comprise at least one reversible solid oxide fuel cell stack assembly for producing at least one product selected from the group consisting of hydrogen and electricity, each of said assemblies producing electricity in response to the feeding of fuel and oxygen bearing gas into the respective assemblies and producing hydrogen in response to the feeding of H₂0 into said respective assemblies.

3. The system according to claim 2, wherein said at least one reversible fuel stack assembly produces electricity and hydrogen in accordance with the amount of fuel, oxygen bearing gas and H₂0 fed into the respective assemblies.

4. The system according to claim 1, wherein said fuel cell/electrolyzer system comprises at least one reversible solid oxide fuel cell stack assembly for exclusively producing hydrogen.

5. The system according to claim 1, wherein said fuel cell/electrolyzer system comprises at least one reversible solid oxide fuel cell stack assembly for exclusively producing electricity.

6. The system according to claim 1, wherein said at least two fuel cell stack assemblies comprise at least one unidirectional fuel cell stack assembly for producing electricity.

7. The system according to claim 5, and further comprising at least one reversible solid oxide fuel cell stack assembly for producing at least one product selected from the group consisting of hydrogen and electricity in accordance with the amount of fuel, oxygen bearing gas and H₂0 fed into said assemblies.

8. The system according to claim 1, wherein at least one stack of said at least two fuel cell stack assemblies produces electricity and at least one stack of said at least two fuel cell stack assemblies produces at least one product selected from the group consisting of hydrogen and electricity in accordance with the amount of fuel, oxygen bearing gas and H₂0 fed into said assemblies.

9. The system according to claim 8, wherein said at least two fuel cell stack assemblies produce electricity.

10. The system according to claim 7, wherein each fuel cell stack assembly of said at least two fuel cell stack assemblies is a reversible solid oxide fuel cell stack assembly for producing a product selected from the group consisting of electricity and hydrogen in accordance with the amount of fuel, oxygen bearing gas and steam fed into said assemblies.

11. The system according to claim 2, wherein said fuel cell/electrolyzer system is operated at a temperature in the range of 800°-950° C. for producing hydrogen.

12. The system according to claim 2, wherein said fuel cell/electrolyzer system receives fuel in the form of a clean gaseous or liquid fuel or fuel mixture.

13. The system according to claim 12, wherein said fuel is selected from the group consisting of natural gas, propane, gasoline, kerosene, ethanol and vegetable oil.

14. The system according to claim 12, wherein said fuel is a gas mixture of at least one gas selected from the group consisting of H₂, H₂O, CO and CO₂ when said fuel cell/electricity system produces electricity.

15. The system according to claim 1, wherein at least one solid oxide fuel cell stack of said at least two solid oxide fuel cell stack assemblies is a fuel cell stack for direct injection of a carbonaceous fuel.

16. The system according to claim 15, wherein said carbonaceous fuel is natural gas.

17. The system according to claim 13, wherein said fuel cell/electrolyzer system receives DC power.

18. The system according to claim 1, wherein said oxygen bearing gas intake tube provides oxygen from external air as the oxygen source.

19. The system according to claim 1, and further including an insulated chamber encasing said fuel cell/electrolyzer system.

20. The system according to claim 1, and further including at least one export power line electrically communicable with said electric connection apparatus for directing some of the produced electricity to an external location.

21. A system for the conversion of chemical energy into electrical energy and/or hydrogen, and/or the conversion of electrical energy into chemical energy, said system comprising:
a fuel cell/electrolyzer system comprising at least two solid oxide fuel cell stack assemblies in communication with each other, wherein said fuel cell/electrolyzer system produces at least one of electricity and pure hydrogen and wherein at least one solid oxide fuel cell stack of said at least two solid oxide fuel cell stack assemblies is a direct injection of carbonaceous fuel solid oxide fuel cell stack;
a compressor in communication with said fuel cell/electrolyzer system for compressing pure hydrogen produced by said fuel cell/electrolyzer system into a high pressure hydrogen;
an apparatus for electrically connecting said fuel cell/electrolyzer system with said compressor to effect said communication for directing electricity produced by said fuel cell/electrolyzer system to said compressor;
a hydrogen connector connecting said fuel cell/electrolyzer system with said compressor for directing hydrogen produced by said fuel cell/electrolyzer system to said compressor;
an intake water feed for connecting said fuel cell/electrolyzer system with an external water source for feeding water into said system;
a fuel feed connector for connecting said fuel cell/electrolyzer system with an external fuel source for feeding fuel into said system;
a water export tube extendable from said fuel cell/electrolyzer system for directing heated water away from said system;
an oxygen intake tube connectable to said fuel cell/electrolyzer system for providing oxygen to said system from an oxygen source;
an exhaust tube extendable from said fuel cell/electrolyzer system for directing waste gas away from said system; and
a high pressure hydrogen connector extendable from said compressor for directing the high pressure hydrogen away from said compressor to an external storage facility.

22. The system according to claim 21, wherein said system receives natural gas for fueling said system for the production of electrical energy.
